(19) United States
(12) Patent Application Publication
(10) Pub. No.: US 2022/0408688 A1
(43) Pub. Date: Dec. 29, 2022

(54) Hog Trap with Anti-climb and Anti-dig Bars

(71) Applicant: George M. Green, Argyle, TX (US)

(72) Inventor: George M. Green, Argyle, TX (US)

(21) Appl. No.: 17/808,254

(22) Filed: Jun. 22, 2022

Related U.S. Application Data
(60) Provisional application No. 63/214,117, filed on Jun. 23, 2021.

(51) Int. Cl. A01K 1/06

(52) U.S. Cl. CPC A01K 1/0613

(57) ABSTRACT

A hog trap includes a fence assembly to trap the hog, and a trap door. The hog trap has upper and lower ring assemblies. The ring assemblies include bars extending partway across the top and bottom and spaced inwardly from the outer boundary of the cage to restrict hogs from climbing but provide an escape opening for deer at the top and also to restrict digging under the cage at the bottom. A bottom bar assembly is fixed inwardly of and to a lower ring, and a top bar assembly is fixed inwardly of and to an upper ring. The bottom bar assembly and the top bar assembly extend inwardly from the rings. The upper and lower ring are part of the cage and support the fence and the trap door.

### BACKGROUND OF THE INVENTION

Feral pigs and hybrids of boars and feral pigs are a serious problem in the United States. They are very adaptable to different environments and can reproduce very quickly. Such pigs (or hogs) cause perhaps a billion dollars in property and agricultural damage every year in the United States in both wild and agricultural lands. Among that damage is their tendency to damage acres of planted fields in a short time by rooting for their food under the ground with their snouts and tusks. They are, moreover, omnivorous, and thus may also be a danger to animals, including game animals such as deer and turkeys. Trapping hogs is one part of the solution, whether they will be killed in-place or relocated to an acceptable location.

### SUMMARY OF THE INVENTION

An embodiment of the present invention includes a hog trap with an improved design that helps prevent hogs from escaping due to bars extending partway across the top and bottom. The top bars prevent the hogs from climbing out and the bottom bars prevent them from digging out. In particular, the top bars are spaced inwardly from the wire or fencing forming the boundary of the cage and prevent them from using the wire to crawl out because they hit the bar and can't get around it. In particular, the bottom bars are spaced inwardly from the wire or fencing forming the boundary of the cage and prevent them from digging under the edge of the cage because they step on the bars and it blocks them from digging.

An embodiment of the present invention includes a hog trap with bars extending partway across the top and bottom and spaced inwardly from the outer boundary of the cage. A lower ring assembly, for seating on the ground, and about six feet in diameter, includes a bottom bar assembly rigidly fixed to the lower ring, which is at least partly inward of the lower ring and preferably in the same plane. An upper ring assembly, about six feet in diameter, includes a top bar assembly rigidly fixed to the upper ring, which is at least partly inward of the upper ring and preferably in the same plane. The upper bar assembly does not fully close the top of the cage, but leaves a large opening at the top thereof. This can permit deer that get trapped to jump upwards through the top.

Vertical bracing connects the upper and lower ring assemblies and holds the upper ring assembly at a height of about four feet.

A cage door includes a doorframe attached to the interior of the upper and lower ring assemblies, including a bottom frame, top frame, sides, and a trapdoor. The trapdoor includes a bottom edge formed to sit flush against the bottom frame of the doorframe, a top edge to attach a trap release system, side edges slidably retained by the sides of the doorframe, and door fencing supported between the top and bottom edges and the sides. The trapdoor edges (and its height) are substantially shorter than the sides of the doorframe to permit the trapdoor to be set in open mode high enough to permit hog entry into the case, but still permit the trapdoor to be suspended from the top frame of the doorframe.

A wire fence is attached to the upper and lower ring assemblies and extends between them to form the cage. The wire fence extends laterally around the cage between the sides of the doorframe to form an opening for the trapdoor. The trapdoor may also be formed of another sheet material to prevent escape, as could the wire fence.

Additional partial rings, extending laterally around the cage between the sides of the doorframe may also be included, and may be connected to the vertical bracing, to reinforce the cage and fencing.

A trap release system includes a stake for setting into the ground inside the cage adjacent to bait, a line from the top of the stake to the top edge of the trapdoor at an attachment point thereon, and a tether connecting the stake to a portion of the cage opposite the trapdoor. The trapdoor is connected by the line running up from the attachment point at the top of the trapdoor to a pulley suspended from the top frame of the doorframe. The line then runs downwardly to the stake from the pulley.

In an open mode, the trapdoor is suspended by the line being taut via the stake being place in the ground far enough from the trapdoor. This leaves an opening in the cage door, below the trapdoor, for the hogs to enter the trap. In the closed mode, the stake is no longer held in the ground, the trap release system having been triggered, and the line is no longer taut. The permits the trapdoor to fall, closing the cage door and trapping the hogs. The tether retains the stake in the air and prevents it from moving around the inside of the cage.

### BRIEF DESCRIPTION OF THE DRAWINGS

FIGS. 1A & 1B are, respectively, front views of an embodiment of the present invention in open and closed mode.

FIGS. 2A & 2B are, respectively, top views of the device shown in the modes shown in FIGS. 1A & 1B.

FIGS. 3A & 3B are, respectively, a top front oblique view and a top right front oblique view of the device shown in the mode in FIG. 1A.

FIGS. 4 & 5 are each top views of embodiments of the present invention.

### DETAILED DESCRIPTION

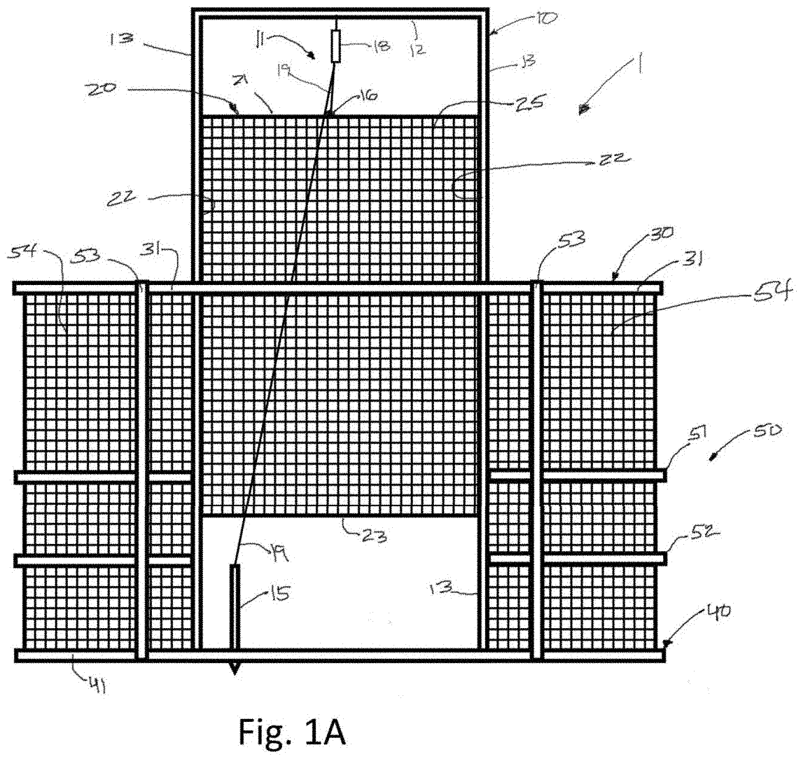

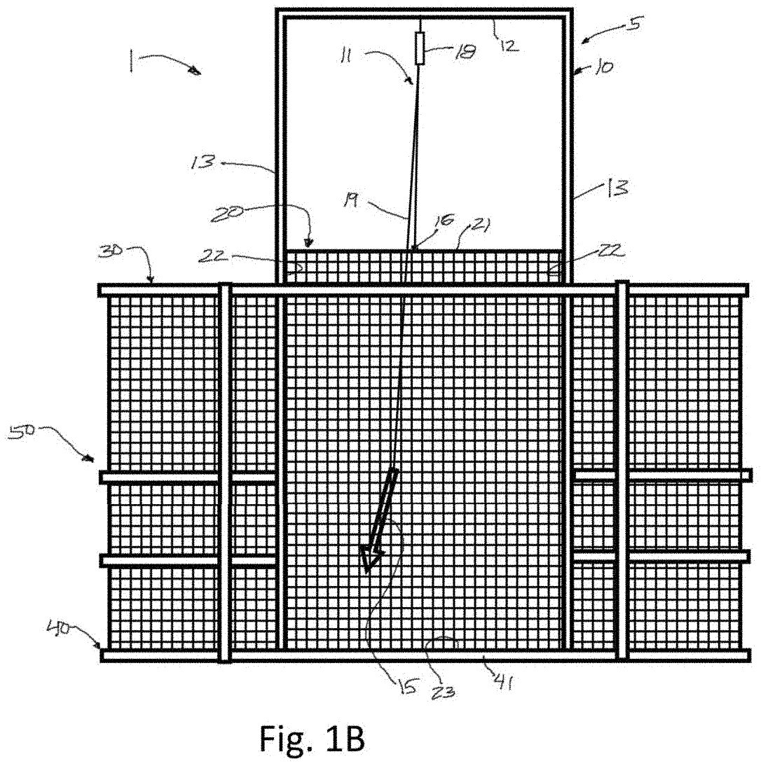

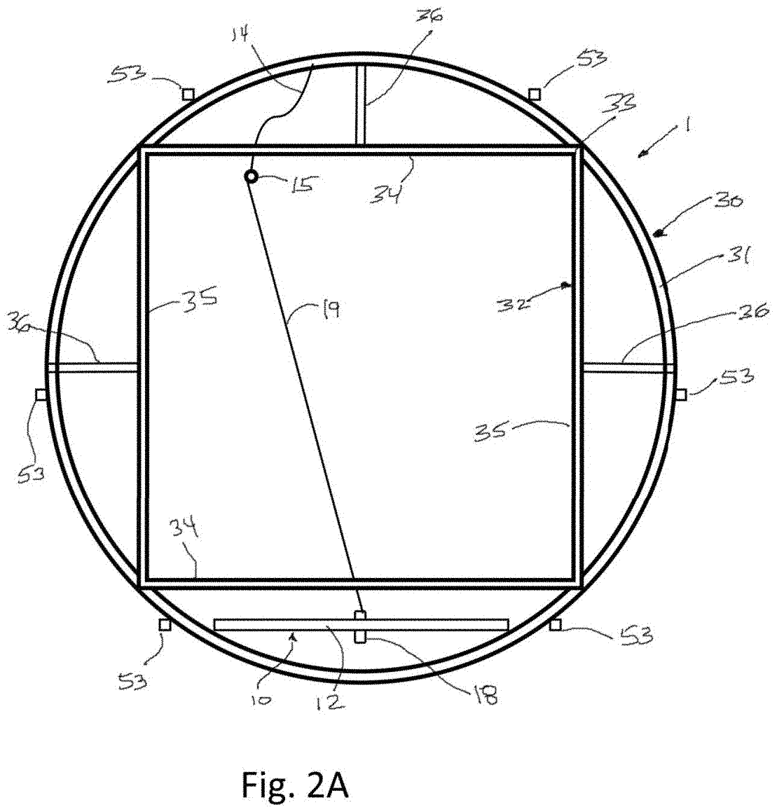

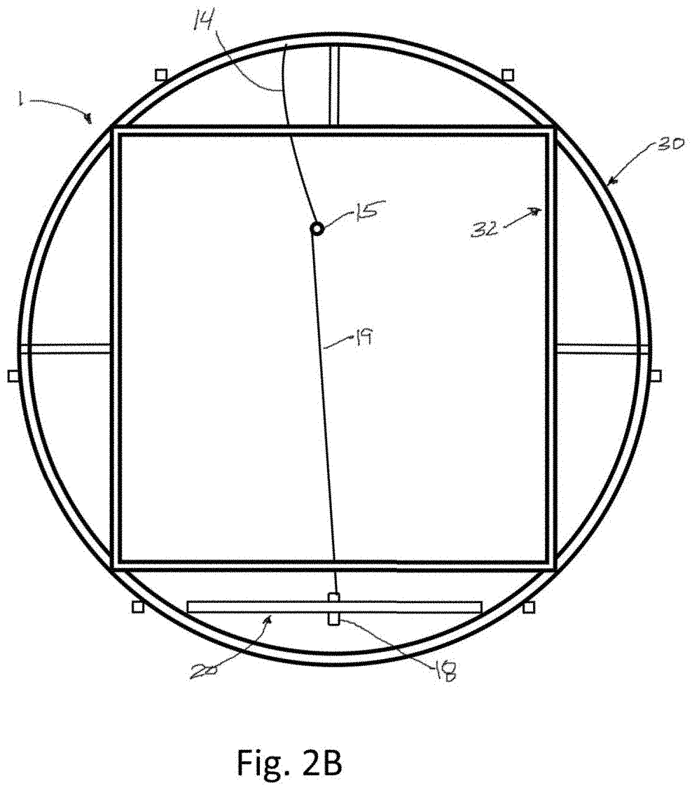

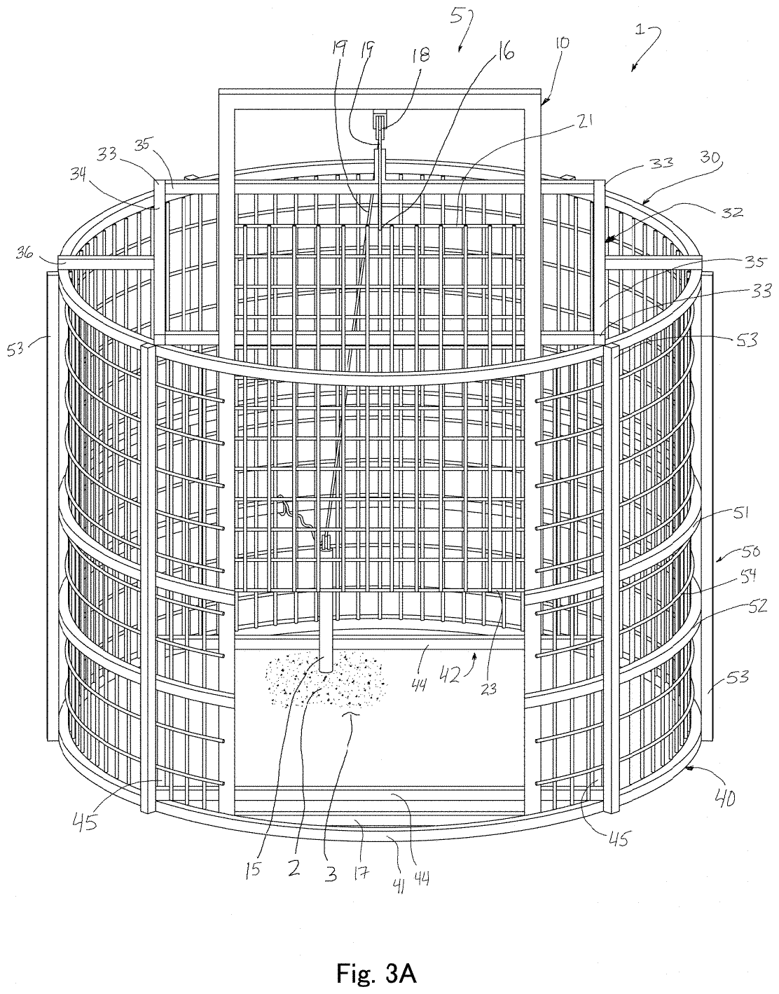

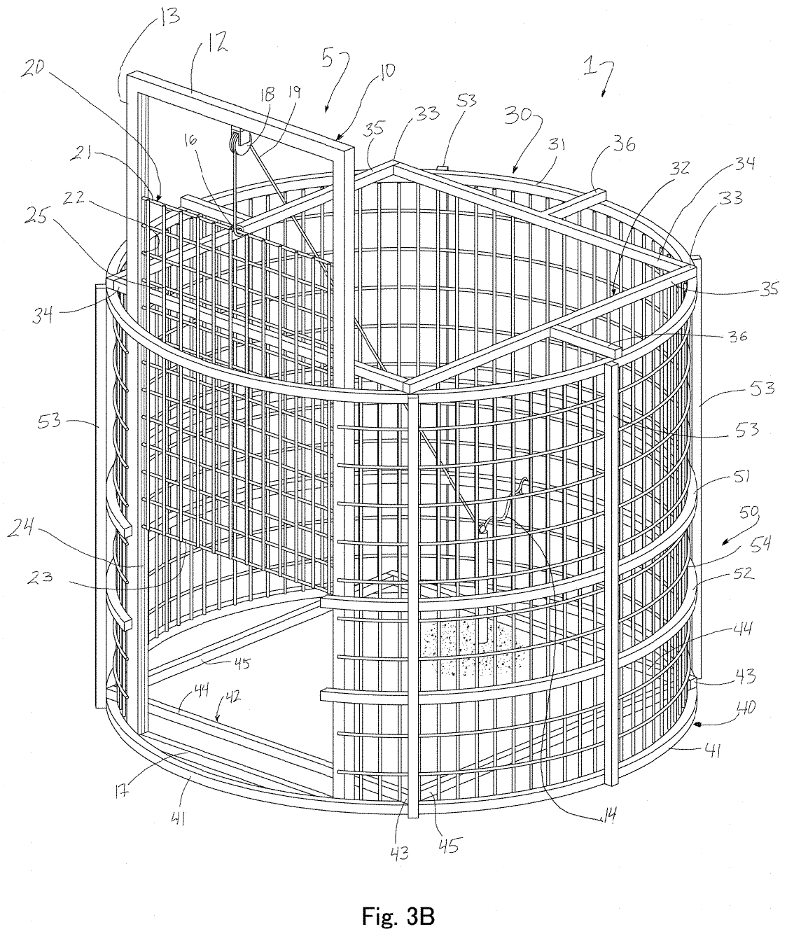

Referring to FIGS. 1A, 1B, 2A, 2B & 3A & 3B, hog trap 1 includes cage door 5, upper ring assembly 30, lower ring assembly 40, and fence assembly 50, and sits on ground 3, and is baited by bait 2 inside trap 1.

Upper ring assembly 30 includes top bar assembly 32 rigidly fixed to upper ring 31. Upper ring 31 is circular, and about six feet in diameter, but could be other shapes such as rectangular, or hexagonal. Top bar assembly 32 is square and at least partly inward of upper ring 31, where the diagonal of the square is the same length as the diameter of the ring, such that corners of the square overlap with upper ring 31. Top bar assembly 32 could be other shapes such as circular, rectangular, or hexagonal, such that it extends at least partly inward of upper ring 31, in an embodiment about 12-18 inches. Top bar assembly 32 includes front and rear top crossbars 34, side top crossbars 35, and top crossbracing radially connecting rear top crossbar 34, and side top crossbars 35 to upper ring 31. Connections 33 are made between the corners of top bar assembly 32 (at the ends of front and rear top crossbars 34 and side top crossbars 35) and upper ring 31. Thus, front and rear top crossbars 34, and side top crossbars 35, extend chord-wise between four points of upper ring 31, extending inwardly about 12-18 inches at the deepest section of the chord, and top bar assembly 32 defines a large escape opening therein. Upper ring assembly 30 is formed of square tubing, but could also be formed of angle iron or strap metal.

Lower ring assembly 40 includes bottom bar assembly 42 rigidly fixed to lower ring 41. Lower ring 41 is circular, and about six feet in diameter, but could be other shapes such as rectangular, or hexagonal. Bottom bar assembly 42 is square and at least partly inward of lower ring 41, where the diagonal of the square is the same length as the diameter of the ring, such that corners of the square overlap with lower ring 41. Bottom bar assembly 42 could be other shapes such as circular, rectangular, or hexagonal, such that it extends at least partly inward of lower ring 41, in an embodiment about 12-18 inches. Bottom bar assembly 42 includes front and rear bottom crossbars 44, side bottom crossbars 45, and bottom crossbracing radially connecting rear bottom crossbar 44, and side bottom crossbars 45 to lower ring 41. Connections 43 are made between the corners of bottom bar assembly 42 (at the ends of front and rear bottom crossbars 44 and side bottom crossbars 45) and lower ring 41. Thus, front and rear bottom crossbars 44, and side bottom crossbars 45, extend chord-wise between different points of lower ring 41. Lower ring assembly 40 is formed of square tubing, but could also be formed of angle iron or strap metal.

Cage door 5 includes doorframe 10, trap release system 11, and trapdoor 20. Doorframe 10 is attached to the interior of upper and lower ring assemblies 30, 40, and includes bottom frame 17, top frame, 12, and sides 13, in a rectangular arrangement. Bottom frame 17 may be in the same plane as lower ring assembly 40 so as to sit on or near ground 3 in operation. Sides 13 provide channel 24 facing inwardly to retain trapdoor 20 but to also permit it to slide up and down therein. Trapdoor 20 includes bottom edge 23, formed to sit flush against bottom frame 17 of doorframe 10, top edge 21, and side edges 22 for being slidably retained by sides 13 of doorframe 10. Door fencing 25 is supported between top and bottom edges 21, 23, and side edges 22, and closes the space formed thereby. Side edges 22 are substantially shorter than sides 13 to permit the trapdoor to have an open mode permitting hog entry while being suspended from top frame 12. Trap release system 11 includes stake 15 for setting into ground 3 inside cage 1 adjacent to bait 2, line 19 connecting stake 15 to top edge 21 of trapdoor 20 at attachment point 16, and tether 14 connecting stake 14 to lower partial ring 52 opposite trapdoor 20. Trapdoor 20 is connected by line 19 running up from attachment point 16 to pulley 18 suspended from top frame 12 of doorframe 10, with line 19 then running downwardly from pulley 18 to stake 15. Doorframe 10 is formed of square tubing, but could also be formed of angle iron or strap metal. Door fencing could be wire fence material or another sheet material not permitting escape.

Fence assembly 50 includes upper partial ring 51 and lower partial ring 52, which extend laterally around cage 1 between sides 13 of doorframe 10. Vertical bracing 53 connect upper ring assembly 30, at upper ring 31 to lower ring assembly 40 at lower ring 31, and to upper partial ring 51 and lower partial ring 52 reinforce the cage and wire fence 54. Wire fence 54 is attached to the upper and lower ring assemblies 30, 40, and to upper partial ring 51 and lower partial ring 52 and extends between them to close cage 1. Wire fence 54 extends laterally around cage 1 between sides 13 of doorframe 10 to form an opening for trapdoor 20. Wire fence 54 could be a wire fence material or another sheet material not permitting escape.

In an open mode, trapdoor 20 is suspended by line 19 being taut via stake 15 being placed in ground 3 far enough from trapdoor 20. This leaves an opening in cage door 5, below trapdoor 20, for the hogs to enter trap 1. In the closed mode, stake 15 is no longer held in ground 3, trap release system 11 having been triggered by hogs seeking bait 2 and dislodging stake 15, and line 19 is no longer short enough to hold trapdoor 20. Trapdoor 20 falls, closing cage door 5 and trapping the hogs inside cage 1. Tether 14 prevents stake 15 from moving around the inside of cage 1.

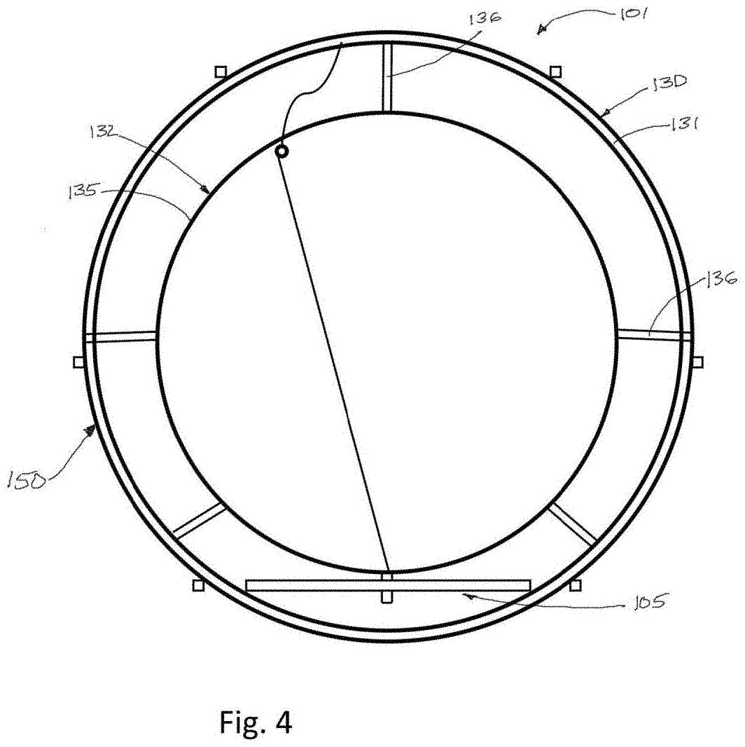

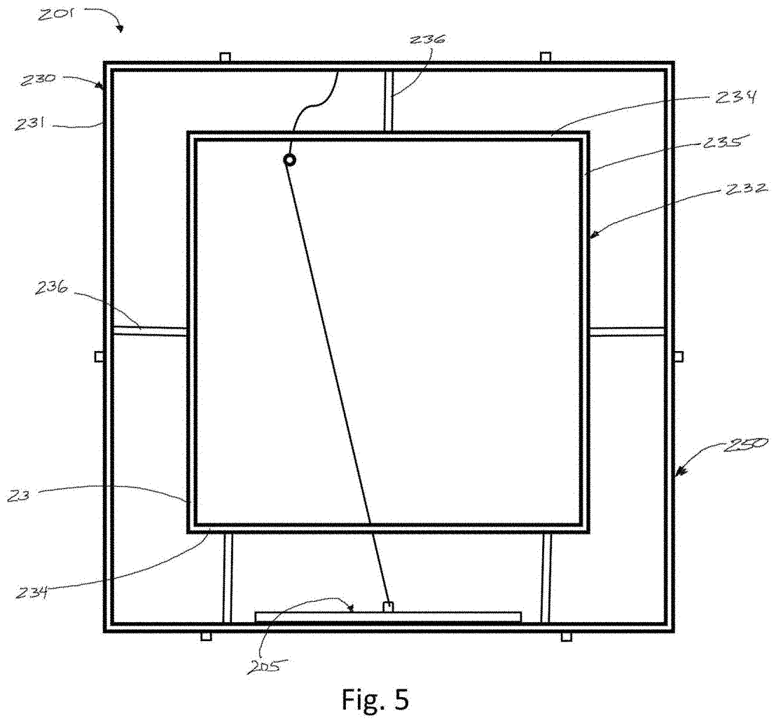

Referring to FIG. 4, hog trap 101 includes cage door 105, upper ring assembly 130, lower ring assembly 140, and fence assembly 150. Hog trap 101 functions very similarly to trap 1, save that top bar 135 of top bar assembly 132 of upper ring assembly 130 and bottom bar 145 of bottom bar assembly 142 of lower ring assembly 140 are each circular, but with a smaller diameter (about 50% or about 65/70/75%, or about two to three feet less) and set approximately equidistantly from upper ring 131 and lower ring 141, respectively. Top bar 135 and bottom bar 145 are supported on the ring assemblies by top bracing 136 and bottom bracing 146 connecting top bar 135 to upper ring assembly 130 and connecting bottom bar 145 to lower ring assembly 140. The configuration of top bar 135 and bottom bar 145, spaced concentrically inwardly (or substantially concentrically inwardly) of upper ring 131 and lower ring 141, defines a large escape opening in upper ring assembly 130. In FIG. 5, upper ring assembly 130 and its components are shown; lower ring assembly 140 and its components are the same shape and are obscured by upper ring assembly 130 and its components.

Referring to FIG. 5, hog trap 201 includes cage door 205, upper frame assembly 230, lower frame assembly 240, and fence assembly 250. Hog trap 201 functions very similarly to trap 1, save that upper frame 231 of upper frame assembly 230 and bottom frame 241 of lower frame assembly 240 are each square or substantially so, with edge length (about 50% or about 65/70/75%, or about two to three feet less) and set approximately equidistantly from front and rear top crossbars 234 and side top crossbars 235 of top bar assembly 232 and front and rear bottom crossbars 244 and side bottom crossbars 245 of bottom bar assembly 242 respectively. Front and rear top crossbars 234 and side top crossbars 235 and front and rear bottom crossbars 244 and side bottom crossbars 245 are supported on the ring assemblies by top bracing 236 and bottom bracing 246 connecting front and rear top crossbars 234 and side top crossbars 235 to upper frame assembly 230 and connecting front and rear bottom crossbars 244 and side bottom crossbars 245 to lower frame assembly 240. The configuration of top bar assembly 232 and bottom bar assembly 242, spaced equidistantly inwardly (or approximately so) of upper frame 231 and lower frame 241, defines a large escape opening in upper frame assembly 230. In FIG. 6, upper frame assembly 230 and its components are shown; lower frame assembly 240 and its components are the same shape and are obscured by upper frame assembly 230 and its components.

1. A hog trap, comprising:
a fence assembly;
an upper ring assembly; and
a cage door;
the fence assembly comprising an upper ring; and
the upper ring assembly comprising a top bar assembly; and
wherein the top bar assembly extends inwardly from the upper ring.

2. The hog trap of claim 1,
the top bar assembly defining an escape opening in the upper ring assembly.

3. The hog trap of claim 1,
the upper ring being circular; and
the top bar assembly being square.

4. The hog trap of claim 3,
wherein a diameter of the upper ring is the same length as a diagonal of the top bar assembly.

5. The hog trap of claim 3,
the upper ring comprising at least four points defined thereon; and
the top bar assembly comprising
a front top crossbar and a rear top crossbar, and
a first side top crossbar connected to the front top crossbar; and
a second side top crossbar connected to the rear top crossbar; and
the crossbars extending chord-wise between the at least four points.

6. The hog trap of claim 5, further comprising
each side top crossbar connecting the front top crossbar and the rear top crossbar.

7. The hog trap of claim 3,
the upper ring comprising at least four points defined thereon; and
the upper ring being connected to the top bar assembly at the at least four points.

8. The hog trap of claim 1, wherein the top bar assembly extends inwardly from the upper ring about 12-18 inches.

9. The hog trap of claim 1,
the upper ring being circular; and
the top bar assembly being circular; and
wherein a diameter of the top bar assembly is smaller than a diameter of the upper ring.

10. The hog trap of claim 1, the top bar being in the same plane as the top ring.

11. The hog trap of claim 1,
the top bar assembly
being rigidly fixed to the top upper ring assembly;
extending inwardly from the upper ring about 12-18 inches; and
defining an escape opening in the top upper ring assembly.

12. The hog trap of claim 1, further comprising
a lower ring assembly;
the lower ring assembly comprising a bottom bar assembly; and
the fence assembly further comprising a lower ring;
wherein the bottom bar assembly extends inwardly from the lower ring.

13. The hog trap of claim 12,
the lower ring being circular; and
the bottom bar assembly being square.

14. A hog trap, comprising:
a fence assembly;
the fence assembly comprising an upper ring and a lower ring; and
an upper ring assembly and a lower ring assembly; and
the upper ring assembly comprising a top bar assembly;
wherein the top bar assembly extends inwardly from the upper ring; and
the lower ring assembly comprising a bottom bar assembly;
wherein the bottom bar assembly extends inwardly from the lower ring; and
a cage door in the fence assembly.

15. The hog trap of claim 14,
the top bar assembly defining an escape opening in the upper ring assembly.

16. The hog trap of claim 15,
the top bar assembly extending inwardly from the upper ring about 12-18 inches.

17. The hog trap of claim 14,
the upper ring and the lower ring being circular; and
the top bar assembly and bottom bar assembly being square.

18. The hog trap of claim 17,
wherein a diameter of the upper ring is the same length as a diagonal of the top bar assembly.
